(19) United States
(12) Patent Application Publication
(10) Pub. No.: US 2011/0101867 A1
(43) Pub. Date: May 5, 2011

(54) LIGHTING APPARATUS, DRIVING CIRCUIT OF LIGHT EMITTING DIODE AND DRIVING METHOD THEREOF

(75) Inventors: Chun-Hsiung Wang, Taipei County (TW); Yao-Sheng Liu, Taipei County (TW)

(73) Assignee: Cal-Comp Electronics & Communications Company Limited, Taipei County (TW)

(21) Appl. No.: 12/643,993

(22) Filed: Dec. 21, 2009

(30) Foreign Application Priority Data
Nov. 3, 2009 (TW) 98137318

(51) Int. Cl. H05B 37/02

(52) U.S. Cl. 315/127

(57) ABSTRACT

A driving circuit suitable for receiving an alternating current (AC) power to drive a light emitting diode (LED) is provided. The driving circuit includes a rectifier circuit, a process unit, an electric energy conversion circuit, and a detection unit. The rectifier circuit rectifies the AC power to output a first operating voltage. The processing unit is coupled to the rectifier circuit and outputs a second operating voltage and a pulse width modulation (PWM) signal. The electric energy conversion circuit is coupled between the rectifier circuit, the processing unit and the LED and drives the LED according to the PWM signal. The detection unit is coupled to the rectifier circuit and the processing unit and detects the first operating voltage. When the first operating voltage is lower than or equal to a threshold voltage, the detection unit outputs a disable signal to the processing unit to disable the PWM signal.

### CROSS-REFERENCE TO RELATED APPLICATION

This application claims the priority benefit of Taiwan application serial no. 98137318, filed Nov. 3, 2009. The entirety of the above-mentioned patent application is hereby incorporated by reference herein and made a part of specification.

### BACKGROUND OF THE INVENTION

1. Field of the Invention

The present invention generally relates to a driving circuit and a lighting apparatus, and more particularly, to a driving circuit of a light emitting diode (LED) and a lighting apparatus using the same.

2. Description of Related Art

Nowadays, light emitting diodes (LEDs) are increasingly used in various products as their light sources thanks to the small volume, low power consumption, long lifespan, and low cost of the LEDs. In addition, LED requires a very low operating voltage (only 1.5-3V), spontaneously emits light, and offers certain brightness that is adjustable through the voltage or the current. Besides, LED offers high shock resistance, vibration resistance, and long lifespan (100,000 hours). Thus, LED is broadly used in various terminal equipments, such as vehicle headlamps, traffic signal lamps, text displays, display panels, large-screen video displays, commercial building lightings, and LCD backlights.

In a general lighting application, the light emitting effect of a LED is adjusted by using a dimmer, and a driving current supplied to the LED is adjusted by a driver chip. In other words, the dimmer receives an AC current and provides a voltage according to a turn-on condition thereof. The driver chip adjusts the current it outputs to the LED, so as to adjust the brightness of the LED, according to the voltage output by the dimmer. However, light flashing may be produced in the LED when the turn-on condition of the dimmer reaches the threshold of turning off the LED.

When the turn-on condition of the dimmer reaches the threshold of turning off the LED, the voltage provided to the driver chip by the dimmer is too low. With the instable voltage, the driver chip cannot drive the LED normally and accordingly LED flashing is caused.

### SUMMARY OF THE INVENTION

Accordingly, the present invention is directed to a driving circuit of a light emitting diode (LED) and a lighting apparatus suitable for a conventional wall-mounting dimmer, wherein if the dimmer is adjusted to a driving threshold and accordingly an operating voltage goes too low, the driving circuit is automatically stopped from driving the LED so that light flashing in the LED is avoided.

The present invention is directed to a driving method of a LED, wherein an adjusted alternating current (AC) power output by a dimmer is automatically detected, and if an operating voltage rectified by the AC power is too low, a pulse width modulation (PWM) signal for driving the LED is disabled to stop driving the LED so that light flashing in the LED is avoided and light dimming is stabilized.

The present invention provides a driving circuit suitable for receiving an AC power to drive a LED. The driving circuit includes a rectifier circuit, a processing unit, an electric energy conversion circuit, and a detection unit. The rectifier circuit rectifies the AC power to output a first operating voltage. The processing unit is coupled to the rectifier circuit and outputs a second operating voltage and a PWM signal. The electric energy conversion circuit is coupled between the rectifier circuit, the processing unit, and the LED and drives the LED according to the PWM signal. The detection unit is coupled to the rectifier circuit and the processing unit and detects the first operating voltage. When the first operating voltage is lower than or equal to a threshold voltage, the detection unit outputs a disable signal to the processing unit to disable the PWM signal.

The present invention also provides a lighting apparatus suitable for receiving an AC power to provide illumination. The lighting apparatus includes a LED and a driving circuit. The driving circuit is coupled to the LED and includes a rectifier circuit, a processing unit, an electric energy conversion circuit, and a detection unit. The rectifier circuit rectifies the AC power to output a first operating voltage. The processing unit is coupled to the rectifier circuit and outputs a second operating voltage and a PWM signal. The electric energy conversion circuit is coupled between the rectifier circuit, the processing unit, and the LED and drives the LED according to the PWM signal. The detection unit is coupled to the rectifier circuit and the processing unit and detects the first operating voltage. When the first operating voltage is lower than or equal to a threshold voltage, the detection unit outputs a disable signal to the processing unit to disable the PWM signal.

According to an embodiment of the present invention, the processing unit outputs the PWM signal according to the disable signal and adjusts the PWM signal according to a feedback signal output by the electric energy conversion circuit.

According to an embodiment of the present invention, the processing unit includes a voltage stabilizer circuit and a PWM circuit, wherein an output terminal of the voltage stabilizer circuit is coupled to the PWM circuit, the voltage stabilizer circuit outputs the second operating voltage, and the PWM circuit outputs the PWM signal.

According to an embodiment of the present invention, the voltage stabilizer circuit receives the first operating voltage to output the second operating voltage to the PWM circuit.

According to an embodiment of the present invention, the detection unit includes a filter, a reference voltage generator, and a hysteresis comparator. The filter is coupled to the rectifier circuit and receives the first operating voltage to output a comparison voltage. The reference voltage generator is coupled to the processing unit and receives the second operating voltage to output a reference voltage. The hysteresis comparator is coupled to the filter and the reference voltage generator and compares the reference voltage and the comparison voltage to determine whether the first operating voltage is lower than or equal to the threshold voltage and outputs the disable signal accordingly.

According to an embodiment of the present invention, the filter includes a first resistor, a second resistor, a first capacitor, a second capacitor, and a third resistor. A first terminal of the first resistor is coupled to the rectifier circuit to receive the first operating voltage. A first terminal of the second resistor is coupled to a second terminal of the first resistor, and a second terminal thereof outputs the comparison voltage. The first capacitor is coupled between the second terminal of the first resistor and the ground. The second capacitor is coupled between the second terminal of the second resistor and the ground. The third resistor is coupled between the second terminal of the first resistor and the ground.

According to an embodiment of the present invention, the reference voltage generator includes a fourth resistor and a Zenner diode. A first terminal of the fourth resistor is coupled to the processing unit, and a second terminal thereof outputs the reference voltage. The Zenner diode is coupled between the second terminal of the fourth resistor and the ground.

According to an embodiment of the present invention, the reference voltage generator includes a fourth resistor and a fifth resistor. A first terminal of the fourth resistor is coupled to the processing unit, and a second terminal thereof outputs the reference voltage. The fifth resistor is coupled between the second terminal of the fourth resistor and the ground.

According to an embodiment of the present invention, the processing unit is an application-specific integrated circuit (ASIC).

According to an embodiment of the present invention, the electric energy conversion circuit is a buck circuit, a boost circuit, or a flyback circuit.

The present invention further provides a driving method of a LED. In the driving method, an AC power is first rectified to output an operating voltage. Then, an operating voltage and a PWM signal are received and a driving signal is output according to the operating voltage and the PWM signal so as to drive the LED. Next, the operating voltage is detected, and when the operating voltage is lower than or equal to a threshold voltage, the PWM signal is disabled to stop driving the LED.

As described above, the present invention provides a lighting apparatus, a driving circuit of a LED, and a driving method thereof, wherein an operating voltage generated by rectifying an AC power is first detected, and when the operating voltage is lower than or equal to a threshold voltage, the driving circuit stops driving the LED so that the problem of light flashing in the LED can be prevented. In addition, according to the present invention, an appropriate operating range is set in the driving circuit, and when a user adjusts a dimmer so that the operating voltage of the rectified AC power goes too low, the driving circuit automatically detects it and stops driving the LED. Thereby, the problem of light flashing in the LED is prevented, and the light dimming of the LED is stabilized.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a lighting apparatus according to an embodiment of the present invention.

FIG. 1B is a circuit diagram of the lighting apparatus in FIG. 1A.

FIG. 1C is another circuit diagram of the lighting apparatus in FIG. 1A.

FIGS. 2˜5 illustrate the waveforms of a first operating voltage and a comparison voltage.

FIG. 6 illustrates a LED driving method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

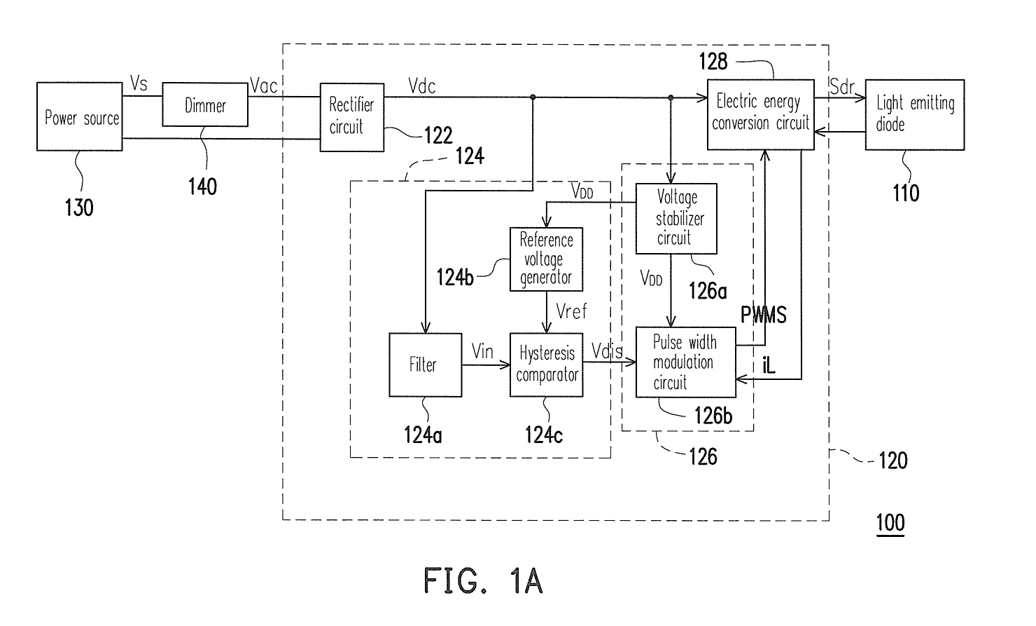

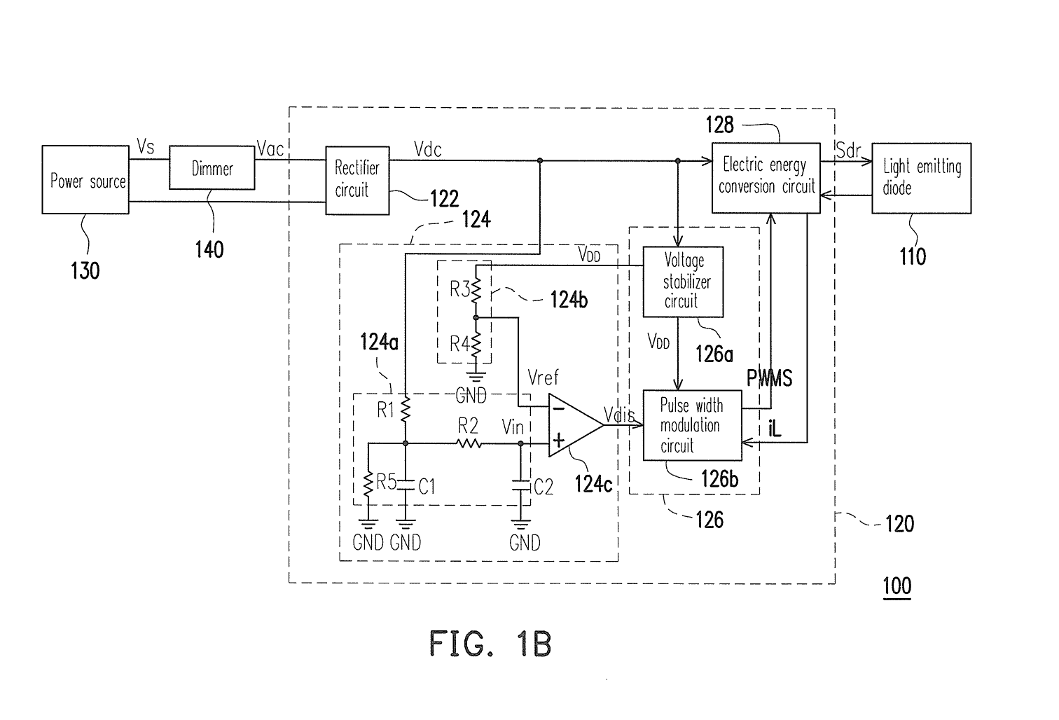

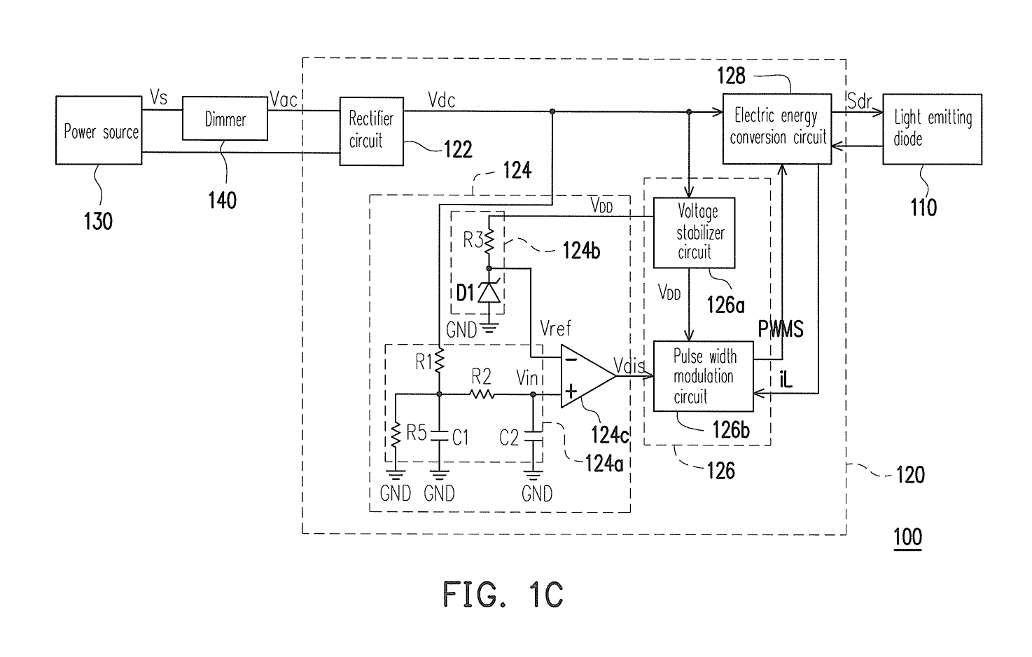

FIG. 1A is a schematic block diagram of a lighting apparatus according to an embodiment of the present invention. Referring to FIG. 1A, the lighting apparatus 100 includes a light emitting diode (LED) 110 and a driving circuit 120. The driving circuit 120 includes a rectifier circuit 122, a detection unit 124, a processing unit 126, and an electric energy conversion circuit 128. In the present embodiment, the lighting apparatus 100 further includes a dimmer 140, wherein the dimmer 140 receives a voltage Vs from a power source 130 and outputs an alternating current (AC) power Vac according to a turn-on condition. In the present embodiment, the dimmer 140 may be implemented by a tri-electrode AC (TRIAC) switch. However, the present invention is not limited thereto.

A TRIAC switch dimmer has 9 different levels (which are, sequentially, a MAX level, 1^{st}˜7^{th} levels, and a MIN level) corresponding to the illumination intensity of the light source, wherein each of the levels is corresponding to a different delay angle α. The larger the delay angle α is, the smaller the turn-on angle is, and accordingly the longer the dimmer 140 is turned off. Namely, the dimmer 140 adjusts the duty cycle and waveform of the AC power Vac by adjusting the turn-on condition of the TRIAC switch. Besides, the power source 130 may be supplied by a commercial AC power or power supplier. However, the present invention is not limited thereto.

In the present embodiment, the rectifier circuit 122 rectifies the AC power Vac to generate a first operating voltage Vdc and sends the first operating voltage Vdc to the detection unit 124, the processing unit 126, and the electric energy conversion circuit 128. When the duty cycle and waveform of the AC power Vac change, the duty cycle and waveform of the first operating voltage Vdc change accordingly. However, the first operating voltage Vdc remains stable due to the existence of a filter 124a. In the present embodiment, the rectifier circuit 122 may be implemented as a bridge rectifier. However, the present invention is not limited thereto.

In the present embodiment, the processing unit 126 further includes a voltage stabilizer circuit 126a and a pulse width modulation (PWM) circuit 126b. The voltage stabilizer circuit 126a receives the first operating voltage Vdc and outputs a stable second operating voltage V_{DD} to the PWM circuit 126b so that the PWM circuit 126b can work smoothly. On the other hand, the PWM circuit 126b generates a PWM signal PWMS for the electric energy conversion circuit 128 according to a disable signal Vdis provided by the detection unit 124 and a feedback signal iL provided by the electric energy conversion circuit 128. In other words, the PWM circuit 126b determines whether to output the PWM signal PWMS according to the disable signal Vdis of the detection unit 124, and the PWM circuit 126b adjusts the duty cycle of the PWM signal PWMS according to the feedback signal iL.

Then, the electric energy conversion circuit 128 drives the LED 110 and adjusts the voltage and current of a driving signal Sdr of the LED 110 according to the PWM signal PWMS, so as to adjust the brightness of the LED 110. In addition, the electric energy conversion circuit 128 outputs the feedback signal iL to the PWM circuit 126b, wherein the feedback signal iL contains the voltage and current status of the driving signal Sdr output by the electric energy conversion circuit 128. In the present exemplary embodiment, the electric energy conversion circuit 128 may be a buck circuit, a boost circuit, or a flyback circuit, or the function thereof may also be a realized by using a buck converter or a boost converter. However, the present invention is not limited thereto.

In addition, the detection unit 124 includes a filter 124a and a hysteresis comparator 124c. The filter 124a is coupled to the rectifier circuit 122 and receives the first operating voltage Vdc to output a comparison voltage Vin. The hysteresis comparator 124c is coupled to the filter 124a and compares a reference voltage Vref with the comparison voltage Vin to determine whether the first operating voltage Vdc is lower than or equal to a threshold voltage and output the disable signal Vdis according to the determination result. Besides, the detection unit 124 further includes a reference voltage generator 124b coupled to the processing unit 126. The reference voltage generator 124b receives the second operating voltage V_{DD} to output the reference voltage Vref. However, the present invention is not limited thereto, and in another embodiment, the reference voltage Vref may also be input from an external circuit.

On the other hand, in the present embodiment, the processing unit 126 is implemented as an application-specific integrated circuit (ASIC). However, the present invention is not limited thereto. Herein the ASIC may be a HV9910 Supertex LED driver, wherein a PWMD pin of the LED driver receives the disable signal Vdis, a CS pin thereof receives the feedback signal iL, a V_{IN} pin receives the first operating voltage Vdc, a GATE pin outputs the PWM signal PWMS, and a Vdd pin thereof outputs the second operating voltage V_{DD}. The definition of pins of foregoing LED driver can be referred to the manufacturer's specification therefore will not be described herein.

FIG. 1B is a circuit diagram of the lighting apparatus in FIG. 1A. Referring to FIG. 1A and FIG. 1B, the filter 124A includes resistors R1 and R2, capacitors C1 and C2, and a resistor R5. The resistor R1 is coupled between the rectifier circuit 122 and the capacitor C1 and receives a first operating voltage Vdc. The capacitor C1 is coupled between the resistor R1 and the ground GND. The resistor R2 is coupled between the coupling point of the capacitor C1 and the resistor R1 and the positive input terminal of the hysteresis comparator 124c. The capacitor C2 is coupled between the positive input terminal of the hysteresis comparator 124c and the ground GND. The resistor R5 is coupled between the resistor R1 and the ground the GND.

After the first operating voltage Vdc is divided by the resistor R1 and the resistor R5 and 2-phase RC filtered by the resistors R1 and R2 and the capacitors C1 and C2, a comparison voltage Vin is output to the positive input terminal of the hysteresis comparator 124c, wherein the comparison voltage Vin is a direct current (DC) voltage corresponding to the first operating voltage Vdc, and the relationship between the comparison voltage Vin and the first operating voltage Vdc can be adjusted by adjusting the divide ratio between the resistors R1 and R2. The hysteresis comparator 124c receives a reference voltage Vref through its negative input terminal and compares the reference voltage Vref with the comparison voltage Vin received through the positive input terminal thereof to determine whether to output a disable signal Vdis.

To be specific, when the comparison voltage Vin is higher than the reference voltage Vref (i.e., the first operating voltage Vdc is higher than a threshold voltage), the output terminal of the hysteresis comparator 124c does not output the disable signal Vdis, and the PWM circuit 126b generates the PWM signal PWMS normally. When the comparison voltage Vin is lower or equal to the reference voltage Vref (i.e., the first operating voltage Vdc is too low), the output terminal of the hysteresis comparator 124c outputs the disable signal Vdis to stop the PWM circuit 126b from generating the PWM signal PWMS (i.e., the PWM signal PWMS is disabled), so as to stop the LED 110 from emitting light. Thereby, light flashing in the LED 110 is prevented when the first operating voltage Vdc goes too low.

It should be mentioned that because the detection unit 124 determines whether the first operating voltage Vdc is higher than the threshold voltage by comparing the comparison voltage Vin with the reference voltage Vref, the reference voltage Vref received by the detection unit 124 provides the threshold voltage, wherein the relationship between the reference voltage Vref and the threshold voltage is similar to that between the first operating voltage Vdc and the comparison voltage Vin. In addition, in the present embodiment, the comparison voltage Vin is obtained through two-phase RC filtering. However, the present invention is not limited thereto, and in another embodiment, the comparison voltage Vin may also be obtained through one-phase RC filtering or other rectification techniques.

In the present embodiment, the reference voltage generator 124b is composed of the resistors R3 and R4 which are coupled to the second operating voltage V_{DD} and the ground GND in series. The reference voltage generator 124b divides the second operating voltage V_{DD} and generates the reference voltage Vref. Besides, due to different circuit design requirement, the value of the reference voltage Vref may be adjusted according to the electrical characteristic of the LED 110, or a suitable value of the reference voltage Vref may also be obtained through experiments.

FIG. 1C is another circuit diagram of the lighting apparatus in FIG. 1A. Referring to FIG. 1B and FIG. 1C, the difference between the two circuits falls on the Zenner diode D1. The Zenner diode D1 is coupled between the resistor R3 and the ground GND, and which converts the second operating voltage V_{DD} into the reference voltage Vref, wherein the value of the reference voltage Vref is controlled by the electrical characteristic of the Zenner diode D1.

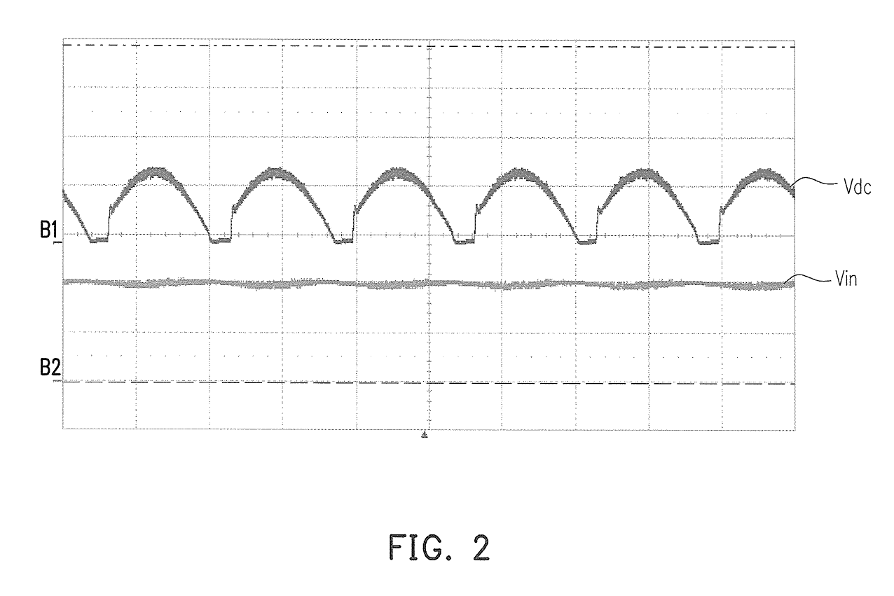

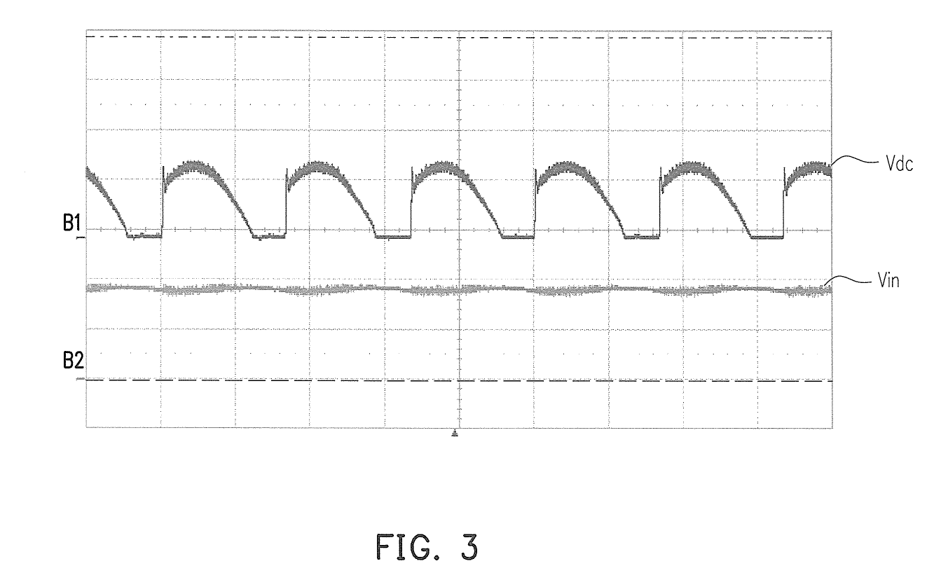

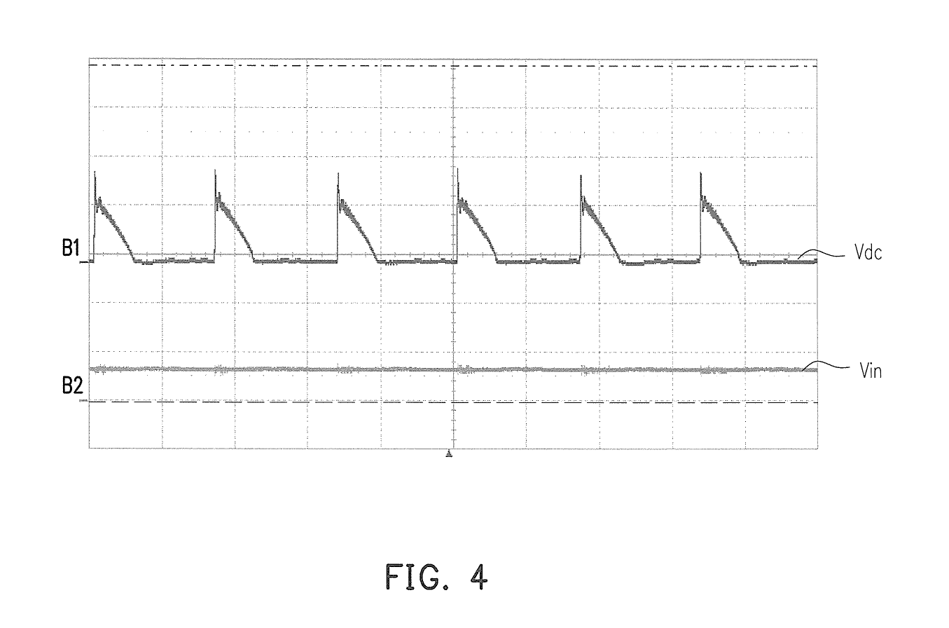

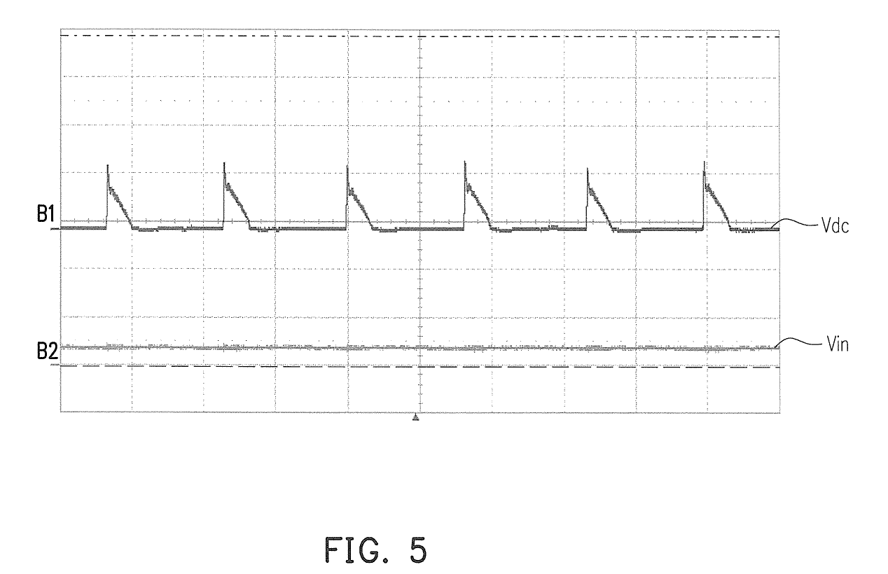

FIGS. 2-5 illustrate the waveforms of the first operating voltage Vdc and the comparison voltage Vin in the lighting apparatus 100 with different delay angle α. To be specific, FIG. 2, FIG. 3, FIG. 4, and FIG. 5 respectively illustrate the waveforms of the first operating voltage Vdc and the comparison voltage Vin with the delay angle α=26° (corresponding to the “MAX” level of the dimmer), α=54° (corresponding to the 3^{rd} level of the dimmer), α=117° (corresponding to the 5^{th} level of the dimmer), and α=135° (corresponding to the 6^{th} level of the dimmer), wherein the reference point B1 is the reference point of the first operating voltage Vdc, and the reference point B2 is the reference point of the comparison voltage Vin. As shown in FIG. 2, the comparison voltage Vin is about 20V when the delay angle α=26°. As shown in FIG. 3, the comparison voltage Vin is about 18V when the delay angle α=54°. As shown in FIG. 4, the comparison voltage Vin is about 6.55V when the delay angle α=117°. As shown in FIG. 5, the comparison voltage Vin is about 3.75V when the delay angle α=135. Thus, the greater the delay angle α is, the smaller the comparison voltage Vin is. In addition, when the comparison voltage Vin is smaller than or equal to the reference voltage Vref, the detection unit 124 outputs the disable signal Vdis to stop the PWM circuit 126b from generating the PWM signal PWMS. Thereby, instable PWM signal PWMS will not be generated and accordingly light flashing in the LED is avoided.

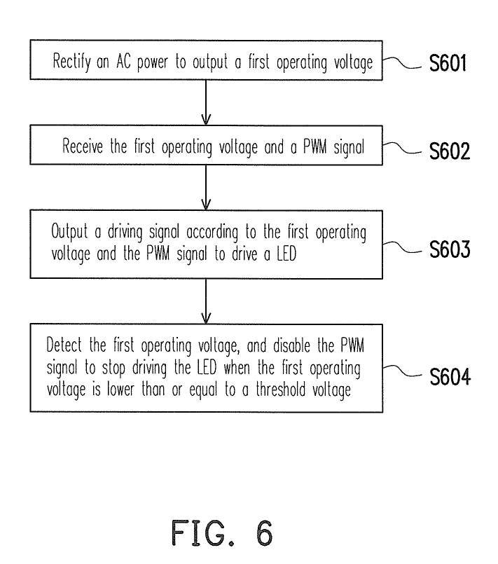

Additionally, a LED driving method applicable to the LED driving circuit 120 described above can be derived from the embodiment of the present invention described above. FIG. 6 illustrates a LED driving method according to an embodiment of the present invention. Referring to FIG. 6, in the present embodiment, an AC power is first rectified to output a first operating voltage (step S601). Then, the first operating voltage and a PWM signal are received (step S602), and a driving signal is output according to the first operating voltage and the PWM signal to drive a LED (step S603). Next, the first operating voltage is detected. When the first operating voltage is lower than or equal to a threshold voltage, the PWM signal is disabled to stop driving the LED (step S604).

As described above, the present invention provides a lighting apparatus, a driving circuit of a LED, and a driving method thereof, wherein an operating voltage generated by rectifying an AC power is first detected, and when a comparison voltage corresponding to the operating voltage is lower than or equal to a threshold voltage, the driving circuit is stopped from driving the LED so that the light flash problem in the LED is avoided. In addition, according to the present invention, the driving circuit generates a PWM signal within an appropriate operation range, and when a user adjusts a dimmer so that the operating voltage generated by rectifying the AC power goes too low, the driving circuit automatically detects it and stops generating the PWM signal so as to stop driving the LED. Thereby, the problem of light flashing in the LED is prevented and the light dimming of the LED is stabilized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving circuit, suitable for receiving an alternating current (AC) power to drive a light emitting diode (LED), the driving circuit comprising:
a rectifier circuit, for rectifying the AC power to output a first operating voltage;
a processing unit, coupled to the rectifier circuit, for outputting a second operating voltage and a pulse width modulation (PWM) signal;
an electric energy conversion circuit, coupled between the rectifier circuit, the processing unit, and the LED, for driving the LED according to the PWM signal; and
a detection unit, coupled to the rectifier circuit and the processing unit, for detecting the first operating voltage, wherein when the first operating voltage is lower than or equal to a threshold voltage, the detection unit outputs a disable signal to the processing unit to disable the PWM signal.

2. The driving circuit according to claim 1, wherein the processing unit outputs the PWM signal according to the disable signal and adjusts the PWM signal according to a feedback signal output by the electric energy conversion circuit.

3. The driving circuit according to claim 1, wherein the processing unit comprises a voltage stabilizer circuit and a PWM circuit, wherein an output terminal of the voltage stabilizer circuit is coupled to the PWM circuit, the voltage stabilizer circuit outputs the second operating voltage, and the PWM circuit outputs the PWM signal.

4. The driving circuit according to claim 3, wherein the voltage stabilizer circuit receives the first operating voltage to output the second operating voltage to the PWM circuit.

5. The driving circuit according to claim 1, wherein the detection unit comprises:
a filter, coupled to the rectifier circuit, for receiving the first operating voltage to output a comparison voltage;
a reference voltage generator, coupled to the processing unit, for receiving the second operating voltage to output a reference voltage; and
a hysteresis comparator, coupled to the filter and the reference voltage generator, for comparing the reference voltage and the comparison voltage to determine whether the first operating voltage is lower than or equal to the threshold voltage and output the disable signal accordingly.

6. The driving circuit according to claim 5, wherein the filter comprises:
a first resistor, having a first terminal coupled to the rectifier circuit to receive the first operating voltage;
a second resistor, having a first terminal coupled to a second terminal of the first resistor and a second terminal for outputting the comparison voltage;
a first capacitor, coupled between the second terminal of the first resistor and a ground;
a second capacitor, coupled between the second terminal of the second resistor and the ground; and
a third resistor, coupled between the second terminal of the first resistor and the ground.

7. The driving circuit according to claim 5, wherein the reference voltage generator comprises:
a fourth resistor, having a first terminal coupled to the processing unit and a second terminal for outputting the reference voltage; and
a Zenner diode, coupled between the second terminal of the fourth resistor and a ground.

8. The driving circuit according to claim 5, wherein the reference voltage generator comprises:
a fourth resistor, having a first terminal coupled to the processing unit and a second terminal for outputting the reference voltage; and
a fifth resistor, coupled between the second terminal of the fourth resistor and a ground.

9. The driving circuit according to claim 1, wherein the processing unit is an application-specific integrated circuit (ASIC).

10. The driving circuit according to claim 1, wherein the electric energy conversion circuit is a buck circuit, a boost circuit, or a flyback circuit.

11. The driving circuit according to claim 1, wherein the AC power is an AC power adjusted by a dimmer.

12. A lighting apparatus, suitable for receiving an AC power to provide illumination, the lighting apparatus comprising:
a LED; and
a driving circuit, coupled to the LED, the driving circuit comprising:
a rectifier circuit, for rectifying the AC power to output a first operating voltage;
a processing unit, coupled to the rectifier circuit, for outputting a second operating voltage and a PWM signal;
an electric energy conversion circuit, coupled between the rectifier circuit, the processing unit, and the LED, for driving the LED according to the PWM signal; and
a detection unit, coupled to the rectifier circuit and the processing unit, for detecting the first operating voltage, wherein when the first operating voltage is lower than or equal to a threshold voltage, the detection unit outputs a disable signal to the processing unit to disable the PWM signal.

13. The lighting apparatus according to claim 12, wherein the processing unit outputs the PWM signal according to the disable signal and adjusts the PWM signal according to a feedback signal output by the electric energy conversion circuit.

14. The lighting apparatus according to claim 12, wherein the processing unit comprises a voltage stabilizer circuit and a PWM circuit, wherein an output terminal of the voltage stabilizer circuit is coupled to the PWM circuit, the voltage stabilizer circuit outputs the second operating voltage, and the PWM circuit outputs the PWM signal.

15. The lighting apparatus according to claim 14, wherein the voltage stabilizer circuit receives the first operating voltage to output the second operating voltage to the PWM circuit.

16. The lighting apparatus according to claim 12, wherein the detection unit comprises:
a filter, coupled to the rectifier circuit, for receiving the first operating voltage to output a comparison voltage;
a reference voltage generator, coupled to the processing unit, for receiving the second operating voltage to output a reference voltage; and
a hysteresis comparator, coupled to the filter and the reference voltage generator, for comparing the reference voltage and the comparison voltage to determine whether the first operating voltage is lower than or equal to the threshold voltage and output the disable signal accordingly.

17. The lighting apparatus according to claim 16, wherein the filter comprises:
a first resistor, having a first terminal coupled to the rectifier circuit to receive the first operating voltage;
a second resistor, having a first terminal coupled to a second terminal of the first resistor and a second terminal for outputting the comparison voltage;
a first capacitor, coupled between the second terminal of the first resistor and a ground;
a second capacitor, coupled between the second terminal of the second resistor and the ground; and
a third resistor, coupled between the second terminal of the first resistor and the ground.

18. The lighting apparatus according to claim 16, wherein the reference voltage generator comprises:
a fourth resistor, having a first terminal coupled to the processing unit and a second terminal for outputting the reference voltage; and
a Zenner diode, coupled between the second terminal of the fourth resistor and a ground.

19. The lighting apparatus according to claim 16, wherein the reference voltage generator comprises:
a fourth resistor, having a first terminal coupled to the processing unit and a second terminal for outputting the reference voltage; and
a fifth resistor, coupled between the second terminal of the fourth resistor and a ground.

20. The lighting apparatus according to claim 12, wherein the processing unit is an ASIC.

21. The lighting apparatus according to claim 12, wherein the electric energy conversion circuit is a buck circuit, a boost circuit, or a flyback circuit.

22. The lighting apparatus according to claim 12, wherein the AC power is an AC power adjusted by a dimmer.

23. A driving method of a LED, comprising:
rectifying an AC power to output an operating voltage;
receiving the operating voltage and a PWM signal;
outputting a driving signal according to the operating voltage and the PWM signal to drive the LED; and
detecting the operating voltage, and disabling the PWM signal to stop driving the LED if the operating voltage is lower than or equal to a threshold voltage.
